(19) United States
(12) Patent Application Publication
(10) Pub. No.: US 2010/0294928 A1
(43) Pub. Date: Nov. 25, 2010

(54) LASER ATOM PROBES

(75) Inventors: Joseph Hale Bunton, Madison, WI (US); Thomas F. Kelly, Madison, WI (US); Daniel R. Lenz, Stoughton, WI (US); Scott Albert Wiener, Mount Horeb, WI (US)

Correspondence Address: Intellectual Property Dept.;Dewitt Ross & Stevens SC, 2 East Mifflin Street, Suite 600, Madison, WI, 53703-2865, US

(73) Assignee: Imago AScientific Instruments Corporation, Madison, WI (US)

(21) Appl. No.: 11/720,709

(22) PCT Filed: Dec. 20, 2005
(86) PCT No.: PCT/US2005/046842

§ 371 Date: Jun. 22, 2010

Related U.S. Application Data
(60) Provisional application No. 60/637,912, filed on Dec. 21, 2004.

(51) Int. Cl. G01N 23/225

(52) U.S. Cl. 250/307; 250/306

(57) ABSTRACT

An atom probe includes a specimen mount that can hold a specimen to be analyzed. A detector is spaced apart from the specimen mount. Between the detector and specimen mount Is a local electrode with an aperture. A laser is oriented to emit a laser beam toward the specimen mount at a nonzero angle with respect to the aperture plane, the aperture plane being oriented perpendicular to an ion travel path defined through the aperture between the specimen mount and detector.

### TECHNICAL FIELD

The present invention relates generally to atom probes, also known as atom probe microscopes.

### BACKGROUND

The atom probe (also referred to as an atom probe microscope) is a device which allows specimens to be analyzed on an atomic level. A basic version of a conventional atom probe might take the following form. A specimen mount is spaced from a detector, generally a microchannel plate and delay line anode. A specimen is situated in the specimen mount, and the charge (voltage) of the specimen holder is adapted versus the charge of the detector such that atoms on the specimen's surface ionize and “evaporate” from the specimen's surface, and travel to the detector. Generally, the voltage of the specimen is pulsed so that the pulses trigger evaporation events with the timing of the pulses, thereby allowing at least a rough determination of the time of evaporation. The specimen's atoms tend to ionize in accordance with their distance from the detector (i.e., atoms closer to the detector tend to ionize first), and thus the specimen loses atoms from its tip or apex (the area closest to the detector) first, with the tip slowly eroding as evaporation continues. Measurement of the time of flight of the ionized atoms from the specimen to the detector allows determination of the mass/charge ratio of the ions (and thus the identity of the evaporated atoms). Measurement of the location at which the ions impinge on the detector allows determination of the relative locations of the ionized atoms as they existed on the specimen. Thus, over time, one may build a three-dimensional map of the identities and locations of the constituent atoms in a specimen.

Owing to the number of atoms potentially contained in a specimen, and the time required to collect these atoms, specimens are often formed of a sample of a larger object. Such specimens are often formed by removing an elongated core from the object—often referred to as a “microtip”—which represents the structure of the sampled object throughout at least a portion of its depth. Such a microtip specimen is then usually aligned in the specimen holder with its axis extending toward the detector, so that the collected atoms demonstrate the depthwise structure of the sampled object. The rodlike structure of the microtip also beneficially concentrates the electric field of the charged specimen about its apex (its area closest to the detector), thereby enhancing evaporation from the apex. Microtips are also formed by mechanically and/or chemically removing material from a specimen so as to form series of microtips along the specimen. For example, a dicing saw can be run along spaced parallel lines atop a silicon wafer or other specimen to leave a series of ridges and valleys on the specimen. The dicing saw and specimen can then be rotated 90 degrees relative to each other, and the dicing saw can again be run along spaced parallel lines along the specimen. This results in a series of posts defined on the wafer which can serve as microtips, possibly after further shaping, as by use of focused ion beam milling and/or chemical etching.

Ionizing (evaporating) energy need not be delivered solely by means of electric fields. Prior atom probes have also directed laser pulses at the specimen to heat it and induce ion evaporation, and others have used a charged counter electrode (an electrode having a central aperture) between the specimen and detector to assist in inducing evaporation. However, regardless of their mode of operation, atom probes suffer from complexity, data accuracy issues, and long set-up and operation times (including the time needed for specimen preparation), and improvement in any one or more of these areas would be beneficial.

Moreover, evaporation rate (Er), the number of ions detected per unit pulse, is the primary metric used to control/monitor the atom probe data collection process. Failure to accurately monitor evaporation rate will result in either little or no data collected (e.g., when Er is too low) or too many ionization events being detected (e.g., when Er is too high). If too much data are collected (per unit time), the data can be corrupted by noise or inaccuracies and/or the specimen can fracture due to the increase in the local electric field applied to it.

### BRIEF DESCRIPTION OF THE DRAWINGS

FIG. 1 is a schematic diagram of an atom probe formed in accordance with the present invention.

FIG. 1A is a schematic diagram of a servomotor controlled stage used to control the position of an achromat lens.

FIG. 2 is a diagram illustrating fine beam alignment according to the present invention.

FIG. 3 is a flow diagram illustrating alignment of a laser beam onto a specimen in accordance with the present invention.

FIG. 4 is a flow diagram illustrating fine alignment of a laser beam using a tomography technique.

### DETAILED DESCRIPTION

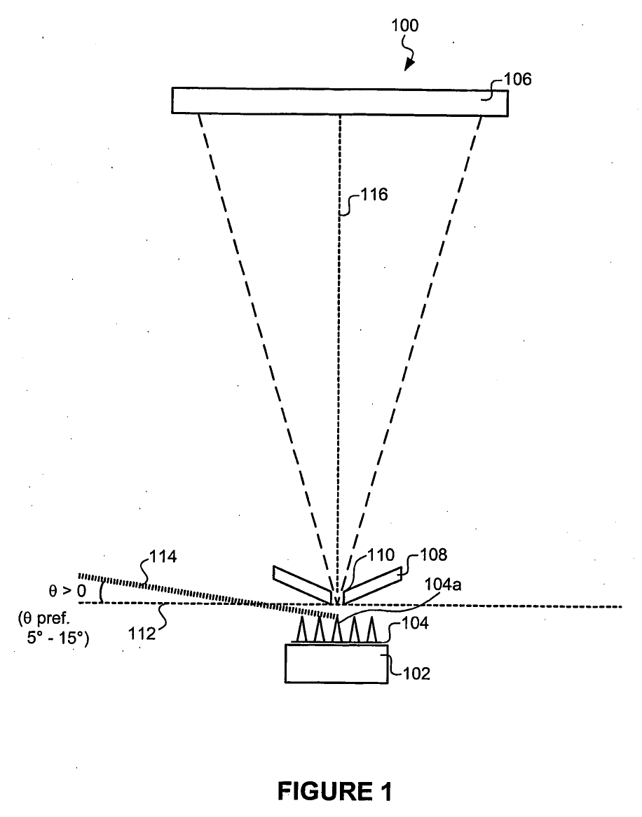

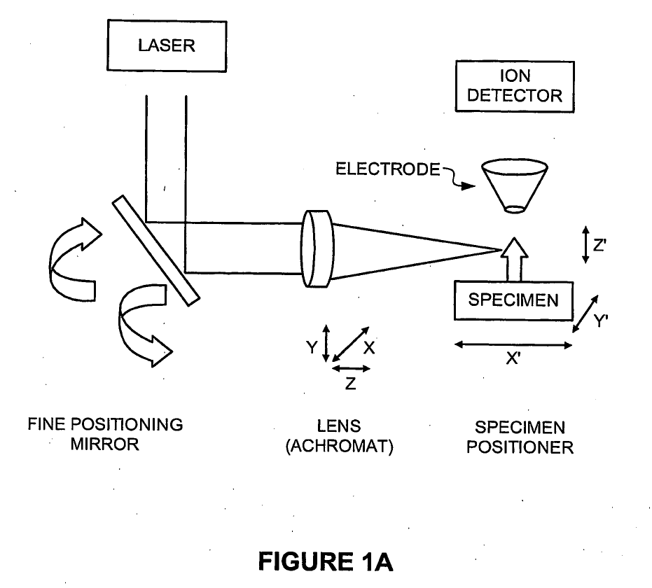

A laser atom probe is schematically depicted by reference numeral 100 in FIG. 1. The laser atom probe 100 includes a specimen mount 102 with a specimen 104 mounted thereon, an opposing detector 106 for receiving ions evaporated from a desired microtip 104a on the specimen 104, and an electrode 108 (or more typically a local electrode) situated between the specimen mount 102 and the detector 106 (with all of these components being situated within a vacuum chamber, which is not shown). In the invention, the specimen 104 is preferably not a single microtip taken from a larger object, but is rather a series of microtips joined by a common substrate—for example, a series of microtips formed on a wafer by the dicing and/or etching process described previously, with the remaining body of the wafer serving as a connecting substrate. The specimen mount 102 is then movable to allow positioning of a desired microtip 104a on the specimen 104 within or closely spaced from the aperture 110 of the local electrode 108, with the apex or other area of interest on the microtip 104a (in one embodiment) being centered within the aperture 110 at a distance of approximately one aperture radius from the aperture plane 112 (the plane which defines the entry of the aperture 110).

A laser beam 114 is then oriented onto the microtip 104a at some nonzero angle with respect to the aperture plane 112 (and/or to the plane of the surface of the specimen 104). In one embodiment, an angle of 5-15 degrees is used, and as a further more specific example, an angle of approximately 8 degrees is used. Prior laser atom probe arrangements have directed beams at 0 degree angles (i.e., parallel to the aperture plane 112 and the surface of the specimen 104—actually a solitary tip in prior applications of the technique), and also did not use local electrodes. Here, a local electrode 108 is used. In some embodiments, the local electrode is not pulsed to provide some fraction of the ionization energy, although in other embodiments the local electrode 108 may be pulsed.

The microtip 104a is charged to some boost voltage amounting to a significant fraction of the ionization energy threshold, the local electrode 108 is uncharged to rest at datum potential (i.e., at ground or some other fixed potential between that of the specimen 104 and the detector 106), and the remainder of the ionization energy is provided by the laser beam 114, which is pulsed to provide timing events for ion departures. In addition, the boost voltage is also pulsed in some embodiments. Since the local electrode 108 is left at datum potential and does not supply ionization pulses, its presence may seem unnecessary, but it has been found that when the local electrode 108 is provided and the microtip 104a is situated at a distance of approximately 0.75X-3.0X the radius of the aperture 110 away from the aperture plane 112, and within the area of the aperture 110 (i.e., within the cylinder projected from the boundary of the aperture 110 to the specimen 104), the local electrode 108 still provides some useful concentration of the electric field preferentially about a single microtip 104a (and thereby reduces the energy needed for the pulsing of the laser beam 114). Additionally, with the foregoing distances and beam angles, the microtip 104a is more evenly illuminated by the laser beam 114 than if the prior 0 degree orientation is used (which provides side illumination only), and is more easily imaged through the aperture 110 of the local electrode 108 (which may be on the order of only 5-50 micrometers in diameter) so that its positioning with respect to the aperture 110 may be verified.

The laser beam 114 may be emitted from a laser situated within the vacuum chamber of the atom probe 100, or the laser may instead be situated outside the vacuum chamber, with mirrors, collimators, lenses, and/or other optics redirecting and focusing the beam 114 as needed to orient it as per the foregoing arrangement.

In one embodiment, the laser atom probe 100 uses a local electrode atom probe manufactured by Imago Scientific Instruments Corporation (Madison, Wis. USA) with a laser having a diode-pumped Ti:Sapphire oscillator (the Verdi-V5 pump laser with a Mira Optima 900-F cavity, both from Coherent, Inc., Santa Clara, Calif., USA), which produces 8 nJ pulses at a nominal repetition rate of 76 MHz. A cavity dumper (the Pulse Switch cavity dumper from Coherent, Inc.) is used to increase the pulse energy to 60 nJ and decrease the repetition rate to the range of 100 KHz-1 MHz. These components are merely exemplary, and other suitable equipment allowing the same or different outputs is available from Coherent, Inc. or from other laser equipment suppliers such as Spectra-Physics, Inc. (Mountain View, Calif., USA). The aforementioned Coherent, Inc. Pulse Switch cavity dumper includes second and third harmonic generators, which may be beneficially utilized in a manner to be discussed later in this document.

The laser beam 114 is in one embodiment focused to less than 1 mm diameter (as received at the microtip 104a), and more preferably less than 0.5 mm. In one embodiment of the atom probe 100, the aforementioned laser is focused to achieve a spot size (beam diameter) of approximately 0.02 mm at the microtip 104a. As previously noted, the laser is used with second and third harmonic generators, thereby allowing tuning of the mean wavelength of the beam 114 from the ultraviolet to the near-infrared ranges and allowing the wavelength to be adjusted to better induce ionization in specimens 104 of different materials.

However, in some cases, a single wavelength does not result in efficient ionization owing to material differences in the specimen 104, with the single wavelength failing to efficiently couple with all components present in the specimen 104. The prototypical atom probe 100 therefore in another alternative embodiment uses a beam 114 containing multiple wavelengths. While this could be done by using multiple lasers directing their beams 116 onto the specimen 104, perhaps after combining their beams 116 with the use of dichroic mirrors or other elements, the use of multiple separate lasers leads to added space and expense, and also leads to added complexity, particularly regarding the need to synchronize pulse timing among different lasers. Therefore, one arrangement is to use the single laser and generate harmonic wavelengths in the same beam 114 by interposing nonlinear crystals or other harmonic-generating optics in the path of the beam 114. In a prototypical atom probe which exemplifies the invention, the beam from the laser is focused into a nonlinear crystal (such as a BBO crystal from EKSMA Photonics Components, Vilnius, Lithuania), which is not depicted in the accompanying drawings. Such a crystal may allow production of a second harmonic, and higher harmonics may be possible as well (possibly by use of further crystals located along the beam).

Achromatic lenses/collimators and/or other optical components may be used to focus and adjust beam diameters for each wavelength so that when they enter the local electrode aperture 110 and impinge upon the specimen 104, they will all be focused to the same beam diameter. It is also contemplated that better laser power transmission to the specimen 104 can be achieved if the laser beam 114 has its plane of polarization oriented at least substantially parallel to the axis of the microtip specimen 104.

To summarize, use of the laser beam 114 provides significant operational advantages over conventional atom probes. One primary advantage is that conventional atom probes are generally limited to analysis of specimens 104 which are at least substantially conductive, since nonconductive specimens 104 require significantly higher boost voltages and overvoltages (and the electric fields of these higher voltages cause substantial stress on the specimen 104, which may then mechanically fracture). Since the laser beam 114 allows operation at significantly lower voltages, the laser atom probe 100 allows analysis of even significantly nonconductive specimens 104, such as organic specimens 104. As a related advantage, the wavelength(s) of the laser (or lasers) used to generate the beam 114 may be adapted for more efficient ionization of specimens 104 of different types, including those which have nonheterogeneous compositions (e.g., specimens 104 containing both conductive and nonconductive regions, inorganic and organic regions, etc.).

Additionally, a suitable laser can generate pulses having widths on the order of picoseconds or femtoseconds. Since specimen ionization occurs over the very narrow window of the laser pulse, ion departure time may be specified with far greater precision, thereby allowing far greater mass resolution than in conventional atom probes (better than 1 in 500 mass-to-charge units). Further, the pulses can be generated with frequencies of 1 kHz-1 MHz, thereby allowing extremely rapid data collection.

However, the arrangement of FIG. 1 introduces several significant challenges, in particular difficulties with accurate focusing of the beam 114 on the desired microtip 104a. Focusing the beam 114 onto the apex of the desired microtip 104a—which may itself have a diameter on the order of tenths or hundredths of millimeters—can be difficult, particularly since the beam 114 may drift over time owing to environmental vibration, thermal expansion and contraction of atom probe components, and so forth. A useful method of focusing the beam 114 on the desired microtip 104a is as follows.

First, the beam 114 is coarsely aligned by directing it toward the approximate area where the apex of a desired microtip 104a will rest when the desired microtip 104a is situated in its analysis location (which, as previously noted, is aligned within the aperture 110 of the local electrode 108 approximately 0.75X-3.0X the radius of the aperture 110 away from the aperture plane 112). This is done with the specimen mount 102 (and the specimen 104 and any microtips 104a thereon) moved away from the aperture, and (optionally) with an array of photosensors (not shown) situated adjacent the local electrode 108 instead. The photosensor array may, if desired, extend from the specimen mount 102 so that exchanging the array and the specimen 104 adjacent the local electrode 108 is easily accomplished with appropriate repositioning of the specimen mount 102. The photosensor array is used to locate the point where the beam 114 impinges, and thus the path of the beam 114 can be geometrically calculated. The beam 114 is then appropriately redirected so that its path crosses the intended location of the apex of a desired microtip 104a when the desired microtip 104a is in its analysis location. If desired, this process can be assisted by use of one or more long-range microscopes and a videocamera to visualize the beam's path and point of impingement (preferably with at least two microscopes being situated orthogonally to the ion travel axis 116, i.e., the axis of the aperture 110, which is also the axis of the flight cone along which ions emitted from the microtip 104a will travel during atom probe microanalysis).

After coarse beam alignment is complete, alignment of the specimen 104 with the local electrode aperture 110 may be performed in a variety of ways. One method of specimen alignment is to initially use two orthogonal optical microscopes for coarse specimen alignment, and if necessary, follow coarse specimen alignment with field ion microscopy for fine specimen alignment. The coarse specimen alignment process is as follows:
1. Ensure that the laser is off, or that its beam 114 is shuttered.
2. Move the specimen mount 102 until the desired microtip 104a is roughly aligned with the local electrode aperture 110.
3. Using 2-axis translation of the specimen 104 (along the plane perpendicular to the ion travel axis 116), move the specimen mount 102 such that the desired microtip 104a is situated generally along the ion travel axis 116. Optical microscopes orthogonally situated about the ion travel axis 116 at the general location of the aperture plane 112 can be used to verify alignment along both axes of translation.
4. The specimen mount 102 can then be moved parallel to the ion travel axis 116 until the apex or other area of interest on the desired microtip 104a is situated at the desired location with respect to the aperture plane 112 (e.g., so that the apex of the specimen 104 is situated 0.75X-3.0X (and in one embodiment between 0.75X-1.25X) the radius of the aperture 110 away from the aperture plane 112).

If necessary, fine specimen alignment can be accomplished using field ion microscopy (FIM):
1. An imaging gas (e.g., neon) is introduced into the vacuum chamber of the atom probe 100. An imaging gas pressure of approximately 5×10⁻⁶ mbar is usually sufficient.
2. The gain of the detector 106 is adjusted to an appropriate level for FIM.
3. Voltage is then supplied to the specimen mount 102 (and thus the specimen 104 and desired microtip 104a) until an image of the apex of the desired microtip 104a can be obtained on the detector 106.
4. The desired microtip 104a is translated along the two axes of the aperture plane 112 until an unobstructed image is obtained on the detector 106. If the desired microtip 104a is misaligned, the local electrode 108 will occlude a portion of the image.

Finer alignment of the beam 114 on the desired microtip 104a is then preferably performed after specimen alignment, and also periodically during the course of data acquisition to ensure that the beam 114 is still aligned with the apex or other area of interest on the desired microtip 104a.

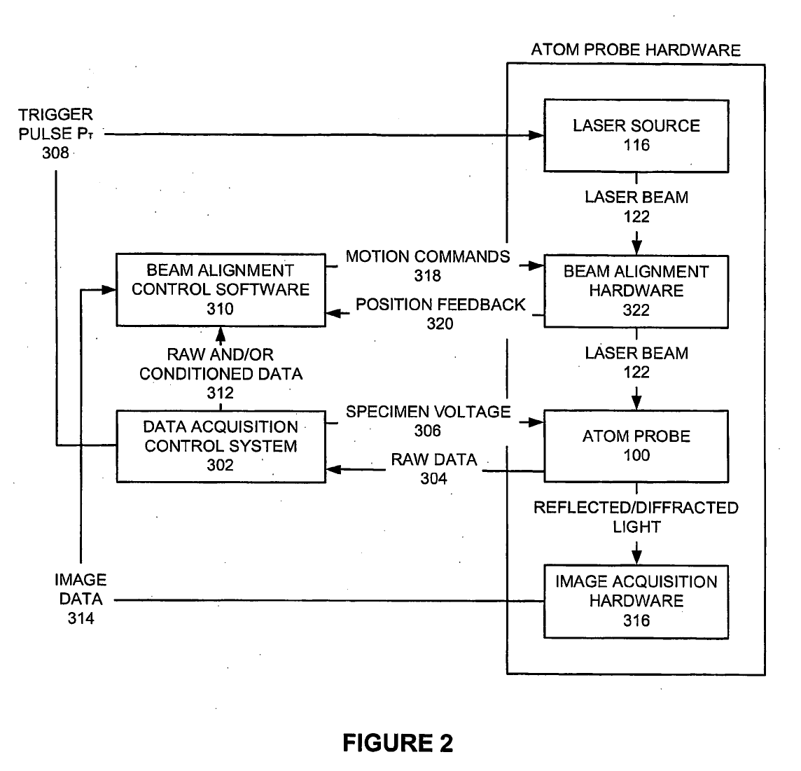

An exemplary control system for fine beam alignment is then shown in FIG. 2, and is designated generally by the reference numeral 300. A data acquisition control system 302 receives raw data 304 from the atom probe 100, and adjusts the (DC) specimen voltage 306 applied to the specimen mount 102 (and in turn to the specimen 104) in accordance with the data 304. This data acquisition control loop repeats throughout the fine beam alignment process and continually adjusts the specimen voltage 306 to obtain a controlled rate of field ionization (Er=constant). The data acquisition control system 302 also supplies the trigger pulse 308 which activates the laser, and encodes the departure time of the resulting laser beam pulse. A second control loop, which runs synchronously or asynchronously with respect to the control loop of the data acquisition control system 302, is executed by a beam alignment control system 310. The beam alignment control system 310 receives raw and/or conditioned atom probe data 312 from the data acquisition control system 302, and also receives image data 314 from image acquisition hardware 316 (videocameras or other optical imaging devices which monitor the specimen 104 within the vacuum chamber), and in turn provides motion commands 318 to (and receives position feedback 320 from) beam alignment hardware 322. The beam alignment hardware 322, which is not shown in the drawings, may be provided by one or more actuators for adjusting the direction of the laser beam 114, and may take the form of actuators which adjust the position of the laser and/or mirrors, lenses, or other optics along the path of the laser beam 114.

Within the beam alignment control system 310, the atom probe data 312 and image data 314 are conditioned to generate one or more control parameters which are indicative of the interaction between the laser beam 114 and the desired microtip 104a, and which are used by the beam alignment control system 310 to finely (and automatically) adjust the alignment of the laser beam 114:

(1) Evaporation rate (the collection rate of any ions detected by the detector 106): The evaporation rate of the specimen should increase as the laser beam 114 approaches the apex of the desired microtip 104a, since the field strength is also strongest at this area of the desired microtip 104a, and therefore the laser beam 114 should induce ionization more easily at the apex than elsewhere on the desired microtip 104a. Accordingly, if the beam alignment control system 310 seeks the area on the desired microtip 104a with the maximum evaporation rate, there is a high likelihood that this area will correspond to the specimen apex.

(2) The voltage applied to the specimen 104. In similar fashion, as the laser beam 114 approaches the apex of the desired microtip 104a, it should be able to induce evaporation with a lower specimen voltage. Thus, if the beam alignment control system 310 seeks the area on the desired microtip 104a where evaporation can be maintained with minimum voltage on the specimen 104, there is a high likelihood that this area will correspond to the specimen apex.

(3) Mass resolution of detected ions. An ion's arrival time can be determined from the detector 106, and if the ion departure time is well known, the mass/charge ratio of the ion should correlate well with known values to allow identification of the ion. However, as the departure time grows uncertain, the correlation decreases. In the laser atom probe 100, departure time variations will begin to increase if it takes longer for the heat of the laser beam 114 to dissipate (i.e., as the effective width of the laser pulse grows wider). Since sensitivity to heat dissipation should be greatest at the apex of the specimen, if the beam alignment control system 310 adjusts the alignment of the laser beam 114 to find the area on the desired microtip 104a with the lowest uncertainty in mass resolution, there is a high likelihood that this area will correspond to the specimen apex.

(4) Signal-to-noise ratio. Similar to mass resolution (item (3) above), the signal-to-noise ratio of the atom probe data is limited by the quality of the beam alignment: as the laser beam 114 deviates from the apex of the desired microtip 104a, well-timed evaporation will decrease and unplanned evaporation will increase. The signal and noise floors will therefore approach each other as the beam 114 deviates from the apex of the desired microtip 104a, and will diverge as the beam approaches the apex. Thus, if the beam alignment control system 310 adjusts the alignment of the laser beam 114 to find the area on the desired microtip 104a with the highest signal-to-noise ratio, there is a high likelihood that this area will correspond to the specimen apex.

(5) Reflected light from the specimen. The image acquisition hardware 316 (i.e., videocameras or other optical imaging devices which monitor the specimen 104 within the vacuum chamber) can monitor the desired microtip 104a. The apex of the desired microtip 104a will have a greater tendency to reflect and/or fluoresce when illuminated by the laser beam 114. Therefore, the beam alignment control system 310 can adjust the alignment of the laser beam 114 to find the area on the desired microtip 104a with peak intensity (or other reflection/emission characteristics), and thereby have a higher likelihood of illuminating the apex of the desired microtip 104a.

(6) Diffracted light from the specimen. Diffracted light is more usefully monitored to maintain alignment of a beam than to initially align a beam 114. Here, the far-field (Fraunhofer) diffraction pattern produced by the desired microtip 104a can be monitored by the image acquisition hardware 316, and the beam alignment control system 310 can adjust the alignment of the laser beam 114 to maintain a constant diffraction pattern, thereby helping to ensure that the beam 114 maintains alignment with the apex of the desired microtip 104a once focused on this location.

There are other possible control parameters (also referred to as measured output parameters or simply parameters) which are indicative of the interaction between the laser beam 114 and the desired microtip 104a, and which can be used to instruct the beam alignment control system 310 to make alignment corrections (e.g., specimen current, temperature, impedance, capacitance). It is also possible to have the beam alignment control system 310 use more than one of these variables, with appropriate weights applied to each selected variable, to better allow the beam alignment control system 310 to more rapidly locate the apex of the desired microtip 104a.

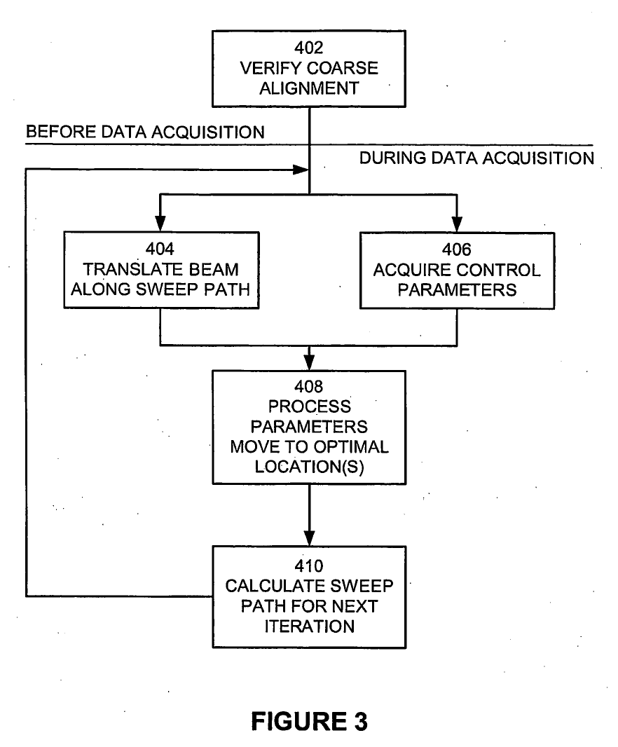

One fine alignment process for the laser beam 114 then proceeds in the manner illustrated in FIG. 3. Initially, at step 402, the user verifies to the beam alignment control system 310 that coarse alignment has been performed, thereby providing reasonable assurance that the beam 114 is directed along a path which roughly coincides with the desired microtip 104a (or its immediate area).

At step 404 in FIG. 3, the user then specifies (or the beam alignment control system 310 defines or recalls) a sweep path—a beam path traveling about the desired microtip 104a—about which the beam 114 will be swept. The beam alignment control system 310 will simultaneously monitor one or more of the aforementioned control parameters (see step 406 in FIG. 3) to seek to meet some predefined alignment criterion, i.e., a standard which is characteristic of the apex of the desired microtip 104a. For example, the beam alignment control system 310 might verify whether the parameter(s) for a swept location has values within a range that would be expected for beam impingement on the apex of the desired microtip 104a; whether the parameter(s) indicates that a location along the sweep is more likely near the apex of the desired microtip 104a than a prior location; and/or whether the parameter(s) “optimally” indicates the apex of the desired microtip 104a (e.g., whether a location along the sweep has the highest evaporation rate, which would seem to indicate the apex of the desired microtip 104a). In essence, the objective is to identify the location(s) along the sweep which optimizes the control parameter(s), thereby locating some point(s) or segment along the sweep path which is believed to be closer to the apex of the desired microtip 104a.

The sweep area can assume a wide variety of sizes and shapes, with an initial sweep area preferably having a size on the order of the diameter of the local electrode aperture 110. As examples, the sweep area might be a circular or square area which can be swept in a spiraling, sinuous, or zig-zagging pattern so that much of the sweep area (and thus some portion of the desired microtip 104a) is swept. Alternatively, as will be discussed below, the sweep area might be defined as a narrow lane, and the sweep might simply occur in one dimension to sweep along the sweep area in a straight line.

While performing the initial sweep of the sweep area, the beam alignment control system 310 will identify the point or other subset of the sweep which has control parameters which meet the alignment criteria (i.e., which appear to be more promising candidate locations for the apex of the desired microtip 104a). After completion of the initial sweep, the beam alignment control system 310 will then take one of two paths to redefine the initial sweep area (step 408 in FIG. 3):

(1) If the beam alignment control system 310 did identify some subset of the sweep having control parameters which best met the alignment criteria—i.e., some single location (a “home location”) was located with control parameters that were optimal in comparison to all locations swept along the sweep area, or if some collection of points most closely met the alignment criteria (e.g., the 10% of sampled locations having the most promising control parameters)—the beam alignment control system 310 will automatically define a new sweep area, one which is reduced in size to encompass at least this subset. As an example, if a single optimal home location is identified, a new sweep area might be defined which is 50% the size of the initial sweep area, and which is preferably centered about the home location.

(2) If the beam alignment control system 310 did not identify some subset of the sweep having control parameters which met the alignment criteria—for example, if all sampled locations along the sweep area had control parameters which did not deviate from each other by more than 10%—the sweep area can be increased rather than decreased (for example, its borders might be expanded outwardly by 50%), since such a result would appear to indicate that the apex of the desired microtip 104a is not within the sweep area. Alternative approaches are possible; for example, the beam alignment control system 310 could simply define another initial sweep area having the same size, and which is offset from the first in some direction in the plane perpendicular to the ion travel axis 116. If this sweep area does not result in at least one location having control parameters which met the alignment criteria, the beam alignment control system 310 can continue to define sweep areas about the initial one until some promising location(s) is found.

Once the sweep area is redefined in step 408, the process may continue to step 410, and a new sweep area may be swept by the beam 114 using a sweep path which is finer (in the case of a smaller sweep area) or coarser (in the case of a larger sweep area), in the sense that the paths traversed by the beam 114 will have closer or more distant spacing. The sweep path preferably takes the same form as in the prior sweep, i.e., it preferibly uses the same sinuous, zig-zagging, spiral, etc. path which is merely compressed or enlarged in scale to cover much of the area of the new sweep area. During the new sweep, the beam alignment control system 310 again monitors the control parameters versus the alignment criteria to seek the location(s) which optimally indicate the presence of the apex of the desired microtip 104a. Once the new sweep is completed, the sweep area is again redefined (shrunk or expanded) and swept with the control parameters being monitored versus the alignment criteria. The process continuously repeats in this manner, with the sweep area being iteratively shrunk about the home (optimal) location(s) until the alignment criteria are met to some predefined level of accuracy. Once this occurs—for example, once the control parameters of an identified home location do not significantly change between subsequent sweeps—the sweeping may be halted, and it can be assumed that the identified home location corresponds to the apex of the desired microtip 104a.

Numerous variations of the foregoing fine beam alignment process are possible. As one example, the beam alignment control system 310 could increase the sampling rate along the sweep path if the control parameters are converging on the alignment criteria, and can decrease the sampling rate if divergence occurs. It is also possible that the sweep area and/or sweep path might be immediately redefined once divergence is noted, so that the sweep area is immediately redefined about the area of convergence. Additionally, the sweep areas and sweep paths may take a wide variety of forms, and they need not take identical form from one sweep to the next; for example, one sweep might take the form of a straight line along an X axis, and the next sweep might take the form of a straight line along a Y axis defined about the home location in the prior sweep. It is also possible that the process might occur semiautomatically; for example, a plot of the control parameters might be displayed to the user, who would then have the opportunity to manually define a new home location for the next sweep.

Once fine alignment has been achieved, the laser atom probe 100 may begin data acquisition: the specimen 104 and detector 106 may each be charged to levels conducive to ionization of the specimen 104, and the laser beam 114 may be pulsed onto the desired microtip 104a to add sufficient energy that ionization occurs. Since the laser beam 114 may drift over time, the foregoing beam fine alignment process may periodically be repeated during data acquisition, perhaps after a certain number of data acquisition cycles occur, and/or after certain parameters (such as evaporation rates, mass resolution, etc.) appear to indicate that the beam 114 is no longer centered on the desired area of the microtip 104a. Data acquisition need not be ceased during such fine alignment, since the data obtained from data acquisition may be used to generate many of the control parameters. Stated differently, data acquisition from the atom probe 100 may proceed in standard fashion, with the acquired data being monitored versus alignment criteria to verify whether the beam 114 is still directed at the apex of the desired microtip 104a, and if the alignment criteria are not met, sweep areas may be defined and sweeping may be performed to re-locate the apex of the desired microtip 104a.

The data acquisition for the fine alignment technique discussed above and below refers to the monitoring of output parameters, such as by the use of a detector of some type, to determine how accurately the laser beam is focused. The parameters include, without limitation, reflected light, mass-resolution of detected ions, specimen current, temperature, etc. . .

### Laser Beam Focusing

Once the laser beam is aligned to the specimen it is possible to improve operation (increase coupling to the apex and reduce illumination of the shank thus reducing thermal tail, the chance of specimen fracture etc.) by optimizing the focus of the beam on the tip. One method to accomplish this is to vary the laser beam focus (Z) while monitoring one or more output parameters (e.g., Er). The focus can be controlled by moving the physical position of a lens (e.g., an achromat) interposed between the laser source and the specimen (FIG. 1A). When the focus is optimized the beam alignment process may be repeated or continue with data acquisition.

These steps can be repeated in and iterative fashion if necessary to further increase the accurate placement of the laser beam focal spot on the apex (or other “sweet spot”) of the specimen. As the specimen erodes or changes position for some other reason during analysis the process can be repeated.

### Tomogram Method

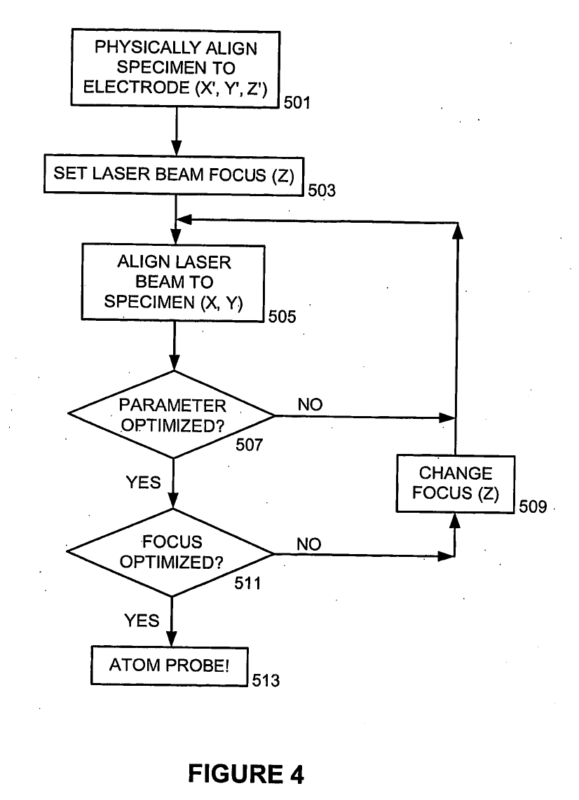

Turning to FIG. 4, a variation of the above routine involves monitoring one or more output parameters while changing three control inputs (beam position (X), beam position (Y) or beam focus (Z)). First at box 501, the specimen is physically aligned to the electrode. The focus (Z=constant) can be set at box 503. At box 505, the beam position (X then Y) is incremented in raster fashion while measuring an output parameter (e.g., Er). Then, at box 509, the focus (Z=Z+1) is changed and again increment (or raster) the beam position (X then Y) while measuring the output parameter (e.g., Er).

This is analogous to the process employed in computer aided tomography—i.e. building a slice-by-slice array of data indicating the value of some parameter (e.g., Er). The beam profile is effectively mapped with respect to the specimen in 3 dimensions. Once the beam profile is mapped, the data is examined at boxes. 507 and 511 and used to locate the optimal beam position (X, Y) and beam focus setting (Z). By calculating the full width at half maximum (FWHM) of the measured parameter (e.g., Er), the optimal X-Y spot location can be located as a function of focus (Z).

Thus, assuming a X, Y, and Z coordinate space, the output parameter is measured by the detector at each possible discrete X, Y, and Z setting for the laser beam. A 3-D map of the output parameter can then be obtained. Using this 3-D map, the optimal alignment and focus of the laser beam can be determined.

### Live Raster Method

Another variation involves acquiring actual atom probe data while executing a small X-Y raster similar to cathode ray tube (CRT) television scan. Once the laser beam and specimen are aligned to some level, the beam may be rastered in a small X-Y region (nominally 25×25 microns) while acquiring data—resulting in a vibration and drift immune automated X-Y alignment. The laser pulses that “miss” the specimen will not generate data—they will not cause ionization events, hence the Er will be a fraction of that expected during “static” (non-rastered) pulsing. This rastering will form a “frame” of output parameter information. New frames are generated once a previous frame has been captured. In this manner, a “movie” of multiple frames can be generated that shows the output parameter (such as Er) over time.

The laser pulse rate can be higher than the “static” mode—limited by the ability to de-convolve initial laser pulses with detected ions. There is a need to be able to match laser pulses with detected ions corresponding to that particular pulse. The laser starts the time-of-flight (TOF) clock, the detected ion stops it. Thus, there is a need to be able to match “stops” with “starts” or the TOF measurement will be inaccurate.

Each X-Y raster “frame” can be buffered and a moving average of the displayed parameter (e.g., Er) can be displayed. A 3-D profile can be plotted and the selected parameter peak can be detected. The software can auto-lock on the peak and dynamically compensate for drift or specimen to electrode realignment.

### Moving Specimen

Another variation involves positioning the beam and electrode then moving the specimen into the optimal position. Specimens are typically mounted on 3-axis micro-positioners enabling the precise positioning of an individual micro-tip (or one chosen from an array of micro-tips) with respect to the electrode.

### Adjusting Polarization

Another variation involves changing the orientation of the polarization of the laser beam. Orienting the laser polarization with the tip axis can maximize power transmission. This could be done after the beam has been focused on the tip or accomplished in the same manner as focusing the beam. A parameter (e.g., Er) can be monitored as a function of beam polarization. An optimal degree of polarization can be selected for a given specimen.

### Astigmatic Laser Pulse

In another aspect of the present invention, when optics are designed for focusing to a small spot, they are generally astigmatic to the maximum extent practicable. This results in a nominally circularly-symmetric focused spot. In one embodiment, astigmatism is introduced intentionally with stigmatic optics. For simplicity, consider a single axis of astigmatism. This will have the effect of changing the focal length of the optics along one axis. In this manner, the laser spot may be focused such that its smallest spot in the direction of the tip axis is achieved at the specimen plane. The laser probe will then be defocused in the direction perpendicular to the long axis of the specimen. The laser alignment thus will be less sensitive to misalignments in the lateral direction. The intensity will be less than a fully focused laser spot, hence additional beam energy will be required.

### Mechanical Configuration

In one embodiment, a 3-axis (X, Y, Z) dc servomotor controlled stage is utilized to control the position of an achromat lens (FIG. 1A). This yields a medium resolution X-Y control of beam position and a medium to fine control of beam focus. A 2-axis (pitch and yaw) piezo-electrically controlled gimbal is used to position a mirror to yield fine X-Y control of beam position.

Some embodiments of the laser atom probe 100 are shown in the drawings and described above merely to illustrate possible features of the laser atom probe 100 and the varying ways in which these features may be combined. Modified versions of the laser atom probe 100 are also considered to be within the scope of the invention. Following is an exemplary list of such modifications.

First, it is notable that a wide variety of operational modes are possible for the atom probe 100 to induce evaporation of the specimen, with any one or more of the specimen mount 102, local electrode 108, and laser beam 114 providing energy to the desired microtip 104a in constant or pulsed fashion. The laser beam 114 is preferably pulsed since the narrow pulse widths achievable with a laser beam 114 are useful to more precisely specify ion departure times (and thus lead to better mass resolution), but steady operation of the laser beam 114, with pulsing of other components (to provide the overvoltage necessary for ionization), is possible. While it is preferred to simply charge the specimen 104 to some boost voltage with an uncharged local electrode, and then supply ionization pulses solely by pulsing the laser beam 114, the use of a pulsing laser beam 114 with an overvoltage (ionizing) pulse also being applied to either or both of the local electrode 108 and/or specimen mount 102 might be beneficial with some types of specimens 104 since this may allow the specimen 104 to remain at a lower boost voltage (and thus a lower field and lower mechanical stress) for the time between pulses, thereby improving the survival of delicate specimens 104 and simultaneously reducing spurious ionization events between pulses (which effectively results in lost data).

Second, apart from laser and electron beams 116, other beams bearing energies at different ranges of the electromagnetic spectrum might be used. Similarly, other forms of energy might be used to impart the boost (non-pulsed) energy, such as microwaves.

The invention is not intended to be limited to the preferred versions described above, but rather is intended to be limited only by the claims set out below. Thus, the invention encompasses all different versions that fall literally or equivalently within the scope of these claims.

I/we claim:

1. An atom probe comprising:
a specimen mount whereupon a specimen to be analyzed may be mounted;
a detector spaced from the specimen mount;
a local electrode situated between the specimen mount and detector, the local electrode having an aperture defined therein;
a laser oriented to emit a laser beam toward the specimen mount at a nonzero angle with respect to the aperture plane, the aperture plane being oriented perpendicular to an ion travel path defined through the aperture between the specimen mount and detector.

2. The atom probe of claim 1 wherein the laser is oriented to emit a laser beam toward the specimen mount at an angle of 5-15 degrees with respect to the aperture plane.

3. A method of performing atom probe analysis using an atom probe having a specimen mount, a detector, and a local electrode situated therebetween, with a local electrode aperture defined within the local electrode and having an aperture plane defined across the entry of the aperture, the method comprising the steps of:
a. providing a specimen on the specimen mount, the specimen having at least one microtip formed thereon and being situated within the aperture but away from the aperture plane by a distance related to the radius of the aperture;
b. orienting a laser beam onto the desired microtip, with the laser beam being oriented at an angle of 1-20 degrees with respect to the aperture plane;
c. while holding the local electrode fixed at a datum voltage:
(1) charging the specimen to a desired boost voltage, and
(2) pulsing the laser to induce ionization from the desired microtip.

4. The method of claim 3 further wherein said specimen includes additional microtips and further moving the specimen to situate another of the microtips within the electric field induced by the aperture after atom probe microanalysis of the first microtip is complete.

5. The method of claim 3 wherein the laser beam is oriented at an angle of 5-15 degrees with respect to the aperture plane.

6. The method of claim 3 wherein said distance is between 0.75X and 3.0X of the radius of the aperture.

7. The method of claim 3 wherein said laser beam includes multiple wavelengths of excitation energy.

8. The method of claim 3 wherein said boost voltage is pulsed.

9. A method of focusing a laser beam of an atom probe onto a specimen mounted on a specimen mount, the atom probe having a detector, the laser beam having a focus (Z) onto said specimen, the method comprising:
(a) monitoring at least one output parameter of said detector when said illumination of said specimen by said laser beam is performed at said focus (Z);
(b) changing the focus (Z) of said laser beam and repeating step (a) at changed focus;
(c) repeating steps (a)-(b) for a range of focuses; and
(d) determining an optimal focus based upon the output parameter information captured by said detector in step (a).

10. The method of claim 9 wherein said output parameter is the number of detected ions perpusle (Er).

11. A method of focusing a laser beam of an atom probe onto a specimen mounted on a specimen mount, the atom probe having a detector, the laser beam having a focus (Z) onto said specimen and being capable of being aimed horizontally and vertically along an X- and Y-axis, the method comprising:
(a) monitoring at least one output parameter of said detector when said illumination of said specimen by said laser beam is performed throughout an X, Y, and Z coordinate space; and
(b) determining an optimal focus based upon the output parameter information captured by said detector in step (a).

12. The method of claim 11 wherein said output parameter is the number of detected ions per pulse (Er).

13. A method of focusing a laser beam of an atom probe onto a specimen mounted on a specimen mount, the atom probe having a detector, the laser beam having a focus (Z) onto said specimen and being capable of being aimed horizontally and vertically along an X- and Y-axis, the method comprising:
(a) rastering the laser beam in an X-Y region while using said detector to acquire an output parameter at each X and Y coordinate to form a frame of output parameter information;
(b) repeating step (a) to generate multiple frames; and
(c) using the frames to generate a temporal movie of said output parameter and to identify features in said output parameter.

14. The method of claim 13 wherein said laser beam is aimed so as to track said features.

15. A method of focusing a laser beam of an atom probe onto a specimen mounted on a specimen mount, the atom probe having a detector, the specimen mount movable along X-, Y-, and Z-axis relative to the laser beam, the method comprising:
(a) monitoring at least one output parameter of said detector when said illumination of said specimen by said laser beam is performed throughout an X, Y, and Z coordinate space;
(b) determining an optimal focus based upon the output parameter information captured by said detector in step (a); and
(c) moving said specimen mount such that said specimen is at said optimal focus point.

16. The method of claim 15 wherein said output parameter is the number of detected ions per pulse (Er).

17. A method of adjusting a laser beam of an atom probe onto a specimen mounted on a specimen mount, the atom probe having a detector, the laser beam having a polarization, the method comprising:
(a) monitoring at least one output parameter of said detector when said illumination of said specimen by said laser beam is performed; and
(b) changing the polarization of said laser beam through a range of polarizations;
(c) determining an optimal polarization based upon the output parameter information captured by said detector in step (a)-(b).

18. The method of claim 17 wherein said output parameter is the number of detected ions per pulse (Er).

19. A method of performing atom probe analysis using an atom probe having a specimen mount, a detector, and a local electrode situated therebetween, with a local electrode aperture defined within the local electrode and having an aperture plane defined across the entry of the aperture, the method comprising the steps of:
a. providing a specimen on the specimen mount, the specimen having at least one microtip formed thereon and being situated within the aperture but away from the aperture plane by a distance related to the radius of the aperture;
b. orienting a laser beam onto the desired microtip, with the laser beam being oriented at an angle of 1-20 degrees with respect to the aperture plane, said laser beam having astigmatism purposefully introduced;
c. while holding the local electrode fixed at a datum voltage:
(1) charging the specimen to a desired boost voltage, and
(2) pulsing the laser to induce ionization from the desired microtip.
